(19) United States
(12) Patent Application Publication
(10) Pub. No.: US 2008/0168744 A1
(43) Pub. Date: Jul. 17, 2008

(54) Composite Door Components

(75) Inventors: Michael D. Petersen, Belmont, MI (US); Herman Allen Damstra, Alto, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Rosewood Works, Inc., Grand Rapids, MI (US)

(21) Appl. No.: 12/015,232

(22) Filed: Jan. 16, 2008

Related U.S. Application Data
(60) Provisional application No. 60/885,262, filed on Jan. 17, 2007.

(51) Int. Cl. E06B 3/00; E06B 3/10

(52) U.S. Cl. 52/784.1

(57) ABSTRACT

A door or the like includes stiles and rails or other components that are made of two different materials. MDF or other suitable material is utilized on a portion of the stiles or rails that faces the outside of the door to provide a readily-paintable finished surface, and another material is used on an inner portion of the stiles or rails to provide support and structural strength. The second material may be a low-cost material to thereby reduce the total cost of the door or other suitable component.

### CROSS-REFERENCE TO RELATED APPLICATIONS

This application claims the benefit of U.S. Provisional Application No. 60/885,262, filed on Jan. 17, 2007, entitled COMPOSITE DOOR COMPONENTS, the entire contents of which are incorporated by reference.

### BACKGROUND OF THE INVENTION

Various types of doors have been developed for residential and commercial applications. One type of door that has become popular is known as a hollow core door. One type of hollow core door includes vertical rails extending along the side edges of the door, and horizontal rails extending along the top and bottom edges of the door. Relatively thin sheets of material (“door skins”) are bonded to the stiles and rails to form the outer faces of the door. Such doors are commonly constructed utilizing stiles and rails around the perimeter of the door. Such stiles and rails are typically made of a medium density fiberboard (“MDF”) material. This material has been used because it provides a surface that can be readily painted. Also, the MDF material accepts screws and the like for mounting hinges to support the door. Although MDF is less expensive than solid wood, it is nevertheless a relatively expensive material, and the use of MDF stiles and rails therefore contributes to the overall cost required to produce a door.

Accordingly, a door construction and method alleviating the above-identified drawbacks of existing doors and construction methods would be beneficial.

### BRIEF DESCRIPTION OF THE DRAWINGS

FIG. 1 is a perspective view of a door according to one aspect of the present invention;

FIG. 2 is a perspective view of a bi-fold door according to another aspect of the present invention;

FIG. 3 is an exploded perspective view of a door according to the present invention;

FIG. 4 is a perspective view of a composite door component according to one aspect of the present invention; and

FIG. 5 is a cross-sectional view of the door component of FIG. 4 taken along the line V-V; FIG. 4.

### DETAILED DESCRIPTION OF PREFERRED EMBODIMENT

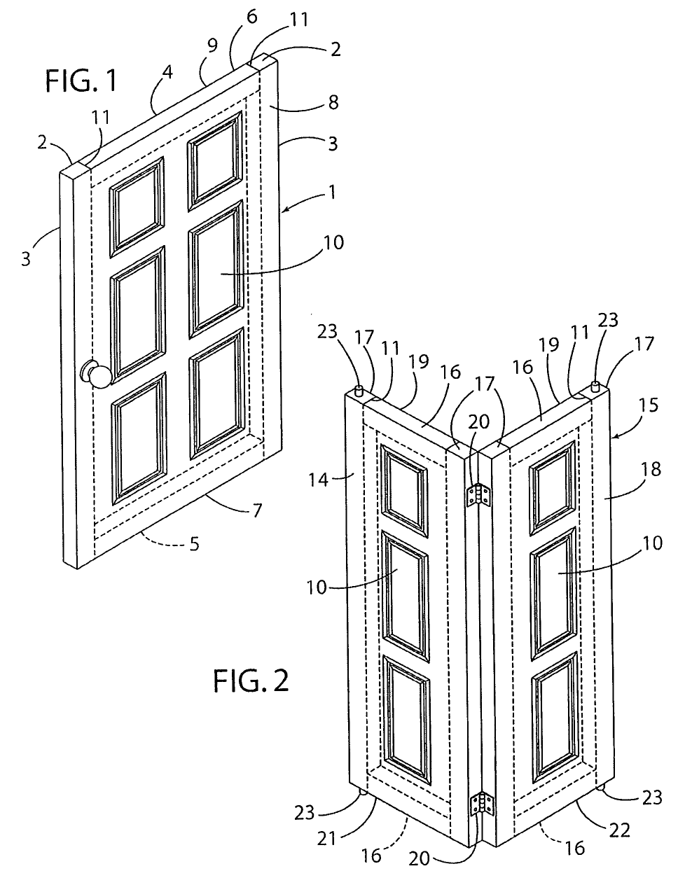

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1, a building component such as a door 1 according to one aspect of the present invention includes a pair of stiles 2 extending along the opposite side edges 3 of the door 1, and an upper rail 4, and a lower rail 5 extending along the upper edge 6 and 7, respectively of the door 1. The door 1 includes relatively thin sheets of materials or “door skins” 8 and 9 which are secured to the stiles 2 and rails 4 and 5. The skins 8 and 9 may include decorative portions 10 forming a “paneled” appearance if desired.

A bi-fold door 15 according to another aspect of the present invention has a construction that is substantially similar to the door 1 of FIG. 1. Door 15 includes a plurality of horizontal rails 16, and vertical stiles 17. Face sheets 18 and 19 are secured to the rails 16 and stiles 17, and hinges 20 interconnect the door halves 21 and 22. The bi-fold door 15 may optionally include decorative portions 10 to provide a decorative appearance. Pins 23 are mounted in rails 16 or stiles 17, and provide for pivotal and/or sliding of the bi-fold door 15 in a known manner.

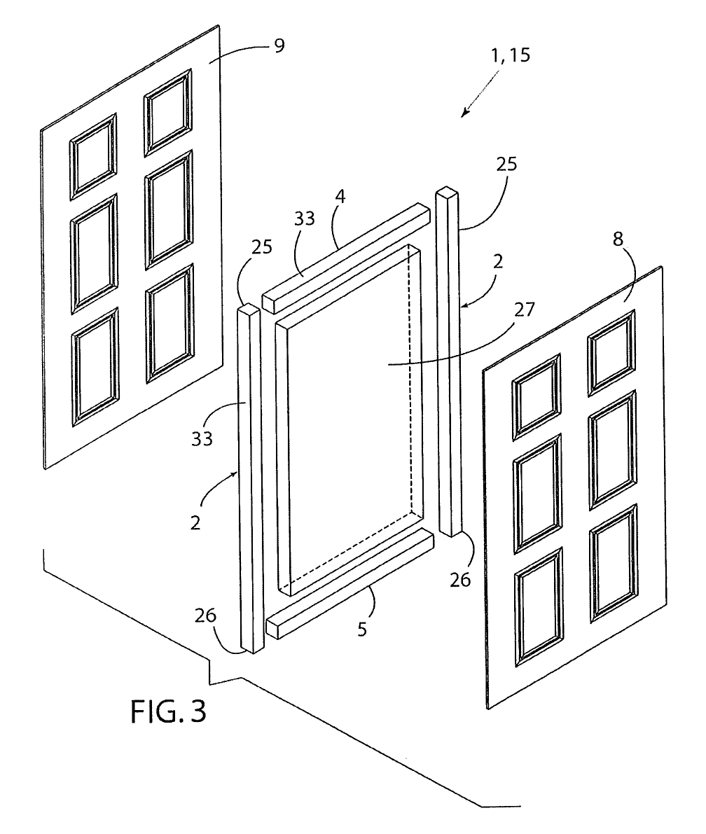

With further reference to FIG. 3, upper and lower rails 4 and 5, respectively are preferably positioned between the upper ends 25 and lower ends 26, respectively, of the stiles 2. This arrangement ensures that the joints 11 (see also FIGS. 1 and 2) are not readily visible when the door is installed. Doors 1 and 15 may optionally include a core 27 made of particle board, cardboard, or other such material according to known constructions.

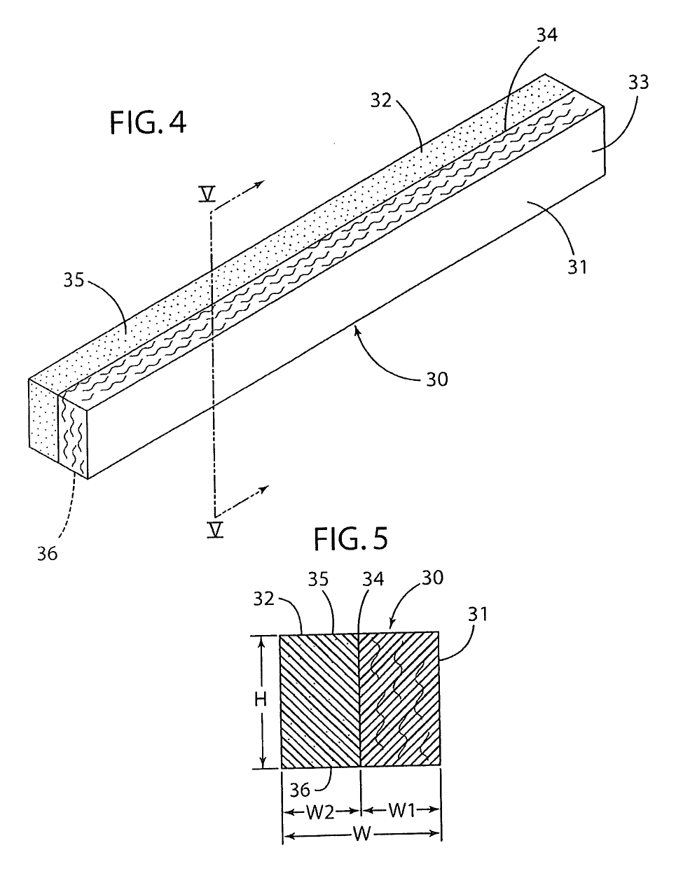

With further reference to FIG. 4, a door component 30 according to one aspect of the present invention includes a first part 31 made of a first material, and a second part 32 made of a second material. The door component 30 may comprise a stile or a rail, or other door component. In a preferred embodiment, the first part 31 comprises an elongated member having a rectangular cross-sectional shape having a width W1 and a height H (FIG. 5). The first part 31 is preferably made of an MDF material or the like, and forms an outside surface 33 that can be readily finished and painted. The second part 32 is made of a second material that is different than the first material. The second part 32 is adhesively bonded to the first part along a joint 34. Second part 32 has width W2 and a height H. In the illustrated example, a Polyvinyl Acetate (PVA) adhesive is utilized to adhesively bond the first part 31 to the second part 32 in a press, clamp, or other suitable fixture. However, it will be understood that a wide variety of other suitable adhesives and/or bonding or fastening techniques may also be utilized. For example, the first part 31 could be secured to the second part 32 utilizing mechanical fasteners rather than adhesive.

The second part 32 is preferably made of a material that is lower in cost than the MDF material of the first part 31. The material of second part 32 may also provide greater strength for receiving screws for mounting the door, and may further provide other improved strength properties. For example, the second part 32 may be made of a chip board material, a particle board material, a foam material, an oriented strand board material, or other suitable material. In general, the first and second parts 31 and 32 have a height “H” chosen to provide the proper overall door thickness for a particular door design. Examples of heights “H” that may be utilized are ⅞ inch, 1⅛ inch, and 1⅞ inch. These sizes represent typical sizes utilized in the industry, but it will be readily understood that other sizes may also be utilized as required. The two parts 31 and 32 together form a width “W” chosen to provide support and stability for lamination of the skins 8 and 9 to the side faces 35 and 36 of the component 30. Although a wide range of sizes and configurations could be utilized, in general the width “W” is typically either about 1⅛ inch or 1⅞ inch. These dimensions are selected to provide the desired degree of stability. The width W may also be chosen to provide the required surface area of side faces 35 and 36 needed for a proper adhesive bond between side faces 35 and 36 of component 30 and the sheets/skins 8 and 9, respectively.

In a preferred embodiment, the first part 31 has a width “W1” of at least about ⅜ inch, and the second part 32 has a width “W2” sufficient to provide an overall width “W” as required for a particular application. For some applications, width W2 could be at least about ¼ inch, and could be as large as ¾ inch or greater. During fabrication of doors 1 and 15, rails and stiles are fabricated according to component 30 and cut to length. The rails and stiles are then adhesively bonded to the outer sheets/skills utilizing known fixtures or the like. After the outer sheets are bonded to the rails and stiles, the outer edges of the doors are machined to provide an outer surface 33 that is within tolerance and/or squareness with respect to overall dimensions for the door, and with respect to the orientation, flatness, surface roughness (finish), and the like. The width “W1” of first part 31 is therefore chosen to provide sufficient material to permit the side edges of the door to be machined to a tolerance after the rails and stiles are laminated and adhesively bonded to the sheets/skins 8 and 9. Although widths W1 of less than ⅜ inch may be utilized, a width W1 of at least about ⅜ inch is presently preferred.

A PVA adhesive available from Industrial Adhesives of Indiana, Inc. of Indianapolis, Ind. is presently preferred to bond first and second parts 31 and 32 together. Although PVA adhesive has been found to be suitable for a variety of materials for parts 31 and 32, it will be understood that other adhesives may be used to bond the first and second parts 31 and 32 together.

As discussed above, during manufacture of the doors 1 and/or 15, the components 30 are first formed by adhesively bonding the first part to the second part 32, and the component 30 is then cut to the proper length to form the stiles and rails as required for a particular application. The stiles and rails are then adhesively bonded to the skins 8 and 9 utilizing PVA adhesive, and the outer side faces or surfaces 33 are then machined smooth. If a core 27 is included in the door 1 or 15, the core 27 is also adhesively bonded to the stiles and rails and/or skins 8 and 9 utilizing PVA adhesive or other suitable adhesive or connector. Because the first part 31 is made of an MDF material, the outer surface 31 can be readily painted and finished as required. Although the outer surface 33 is MDF, the cost of the components is substantially reduced due to the use of a lower cost material for the second part 32. It will be understood that the material used for the second part 32 may be chosen to have the desired material properties to improve the strength or other attributes of the finished door. For example, a material having a high degree of strength may be utilized to provide for the use of screws and the like when mounting hinges to support the door. In this way, a door constructed according to the present invention may provide a very strong construction at a reduced cost, while still providing an outer surface that can be readily finished and painted.

According to another aspect of the present invention, the rails and stiles utilized to fabricate a door 1 or 15 may be made of different combinations of materials. For example, with reference back to FIG. 1, one or more of the stiles 3 of door 1 receive screws to mount hinges to pivotably support door 1. One or both stiles 3 may have a first part 31 made of MDF, and a second part 32 made of particle board, chip board, or the like to provide strength for the hinge mounting screws. However, because the rails 4 of door 1 do not receive screws and also do not experience as large of loads as do stiles 3, rails 4 may have a first part 31 of MDF, and a second part 32 made of Styrofoam or the like to further reduce the cost of door 1.

Pins 23 of bi-fold door 15 (FIG. 2) may be mounted in rails 16 or in stiles 17. When pins 23 are mounted in rails 16, rails 16 may have a first part 31 made of MDF, and a second part 32 made of particle board or the like to provide strength for pins 23. The stiles may have a first part 31 made of MDF, and a second part 32 made of Styrofoam or other very low cost material. In this way, the combinations of materials used to construct the stiles and rails may be chosen to provide the desired degree of strength, while minimizing the cost of the door.

According to another aspect of the present invention, the first part 31 may be made of a colored material such as MDF or other suitable material that has been dyed, stained, or the like to provide the desired finished color throughout the material. The outer surface 31 can then be machined to the final size and shape, and the step of painting surface 31 can be eliminated. In this way, the cost of a door constructed according to the present invention can be further reduced.

The present invention provides a very cost effective way to fabricate a door having stiles and rails. Such doors may have a hollow core construction, or may have a solid core construction. The composite stiles and rails or other components provide a finished, readily-paintable outer surface, while substantially reducing the cost due to the use of other materials away from the finished surface. It will be understood that other components besides doors and the like may also be constructed according to the present invention.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A door construction, comprising:
a pair of horizontally spaced apart, vertically elongated stiles extending along opposite vertical side edges of the door, each stile defining first and second oppositely-facing outer side faces;
upper and lower vertically spaced apart, horizontally elongated rails extending along horizontal upper and lower edges, respectively, of the door, each rail defining first and second oppositely-facing outer side faces;
a first panel member having outer perimeter portions thereof extending over the first outer side faces of the stiles and the upper and lower rails;
a second panel member having outer perimeter portions thereof extending over the second outer side faces of the stiles and the upper and lower rails;
the stiles each including an outer portion made of a medium density fiberboard material forming vertical surfaces extending between the first and second panel members, each stile further including an inner portion adhesively bonded to the outer portion of the stile;
the upper and lower rails including an outer rail portion made of a medium density fiberboard material forming upwardly and downwardly facing horizontal upper and lower surfaces, respectively, extending between the first and second panel members, the upper and lower rails each including an inner portion adhesively bonded to the outer portion of the rail; and wherein:
the inner portions of the stiles and rails are made of a material selected from the group consisting of particle board, chip board, foam, and oriented strand board.

2. The door construction of claim 1, wherein:
the inner portions of all of the stiles and rails are made of the same material.

3. The door construction of claim 1, wherein:
the inner portion of at least one of the stiles is made of particle board or chip board; and
the inner portions of the rails are made of foam.

4. The door construction of claim 1, wherein:
the stiles and the rails have a generally quadrilateral cross-sectional shape.

5. The door construction of claim 4, wherein:
the inner and outer portions of the stiles and the rails are adhesively bonded together along a generally planar joint.

6. The door construction of claim 1, wherein:
the outer side faces of the stiles and the rails define a width therebetween in the range of about 1.125 inches to about 1.875 inches.

7. The door construction of claim 6, where:
the stiles and the rails define a height dimension transverse to the width, wherein the height dimension of each of the stiles and rails is in the range of about 0.875 inches to about 1.875 inches.

8. The door construction of claim 6, wherein:
the inner and outer portions of each of the stiles and rails comprise elongated members having substantially uniform cross-sectional shapes.

9. The door construction of claim 8, wherein:
the outer portions of the stiles and rails have a width of at least about 0.375 inches.

10. A door construction, comprising:
first and second panel members forming opposite side faces of the door, each of the first and second panel members defining a generally quadrilateral perimeter;
a plurality of inner door members disposed between the first and second panel members, the inner door members including:
a pair of stiles extending vertically along portions of the perimeters of the first and second panel members;
a pair of rails extending horizontally along portions of the perimeters of the first and second panel members; and wherein:
at least one of the inner door members has a multi-piece construction including at least an inner member and an outer member, wherein the inner member is made of a first material, and the outer member is made of a second material having substantially different material properties than that of the first material, and wherein the inner member and the outer member of the one inner door member are adhesively bonded together along an elongated joint that extends transverse to the opposite side faces of the door.

11. The door construction of claim 10, wherein:
the outer member of the one inner door member is made of a medium density fiber board material.

12. The door construction of claim 11, wherein:
the inner member of the one of the inner door members is made of a material selected from the group consisting of particle board, chip board, foam, and oriented strand board.

13. The door construction of claim 10, wherein:
the inner member and the outer member have quadrilateral cross-sectional shapes.

14. The door construction of claim 10, wherein:
the inner member and the outer member have cross-sectional areas that are about equal to one another.

15. The door construction of claim 10, wherein:
the inner member has first and second opposite side faces disposed transverse to the opposite side faces of the door and defining a width of at least about 0.250 inches between the first and second opposite side faces.

16. The door construction of claim 15, wherein:
the outer member has first and second opposite side faces defining a width of at least about 0.375 inches between the first and second opposite side faces.

17. The door construction of claim 16, wherein:
the first opposite side faces of the inner and outer members are adhesively bonded together to form the elongated joint.

18. The door construction of claim 17, wherein:
the first and second opposite side faces of the inner and outer members are substantially planar.

19. The door construction of claim 18, wherein:
the inner and outer members are substantially equal in length.

20. The door construction of claim 19, wherein:
the first and second panel members define inner surfaces; and:
the inner door members are adhesively bonded to the inner surfaces of the first and second panel members.
